(19) United States
(12) Patent Application Publication
(10) Pub. No.: US 2012/0081637 A1
(43) Pub. Date: Apr. 5, 2012

(54) BACKLIGHT MODULE AND LIQUID CRYSTAL DISPLAY

(75) Inventor: Tung-Chuan Su, Taoyuan (TW)

(73) Assignee: Global Lighting Technologies Inc., Taoyuan (TW)

(21) Appl. No.: 13/185,506

(22) Filed: Jul. 19, 2011

(30) Foreign Application Priority Data
Sep. 30, 2010 (TW) 99133389

(51) Int. Cl. G02F 1/13357; F21V 7/22

(52) U.S. Cl. 349/65; 362/606

(57) ABSTRACT

A backlight module including a light guide panel (LGP), a light source, and a reflective sheet is provided. The LGP has a light entering surface, a light reflecting surface, and a light exiting surface. The LGP includes a plurality of first light guide micro-structures and a plurality of protruding micro-structures. The first light guide micro-structures are disposed on the LGP and distributed at the light reflecting surface. The protruding micro-structures are disposed on the LGP and distributed at the light reflecting surface. The protruding micro-structures and the first light guide micro-structures are distributed alternatively. The light source is disposed beside the light entering surface. The reflective sheet is disposed at a side of the light reflecting surface and is in contact with the protruding micro-structures. Moreover, a liquid crystal display with the above backlight module is also provided.

### CROSS-REFERENCE TO RELATED APPLICATION

This application claims the priority benefit of Taiwan application serial no. 99133389, filed on Sep. 30, 2010. The entirety of the above-mentioned patent application is hereby incorporated by reference herein and made a part of this specification.

### BACKGROUND OF THE INVENTION

1. Field of the Invention

The invention relates to a backlight module and a liquid crystal display (LCD), and more particularly to a backlight module capable of providing a planar light source with good uniformity and an LCD capable of displaying images with high quality.

2. Description of Related Art

Generally, the LCD consists of a liquid crystal panel and a backlight module. The liquid crystal panel displays an image through the twist of liquid crystal molecules and the effect of the polarizing plates to change the light transmission in different pixel regions and cause variant brightness in the different pixel regions.

Since the liquid crystal molecules do not emit light, a backlight module is needed to provide a planar light source. With the device development tending towards the large size and thin volume, the current backlight module commonly adopts the side type backlight module. The side type backlight module can be combined with the light emitting diodes and the light guide panel, which has the advantage of thinner thickness.

Nevertheless, in the thin type-large sized television such as the LED-TV, the size of the light guide panel are increased accordingly while the large sized light guide panel has the problem that the static electricity would be accumulated easily. Therefore, a partial region of the reflective sheet located below the light guide panel is attracted and attached to the light guide panel owing to the attracting effect of the static electricity. Namely, the partial region of the reflective sheet is attached to the light guide panel and the other region of the reflective sheet is not attached to the light guide panel, which causes variant reflecting effect in different regions. As such, the backlight module is unable to provide uniform planar light source.

### SUMMARY OF THE INVENTION

The invention provides a backlight module capable of solving the problem that the reflective sheet is attached to the light guide panel due to the static electricity to provide uniform planar light source.

The invention provides an LCD having the above-mentioned backlight module and capable of displaying images with desirable quality.

The invention is directed to a backlight module including a light guide panel, a light source, and a reflective sheet. The light guide panel has a light entering surface, a light reflecting surface, and a light exiting surface. The light guide panel includes a plurality of first light guide micro-structures and a plurality of protruding micro-structures. The first light guide micro-structures are disposed on the light guide panel and distributed at the light reflecting surface. The protruding micro-structures are disposed on the light guide panel and distributed at the light reflecting surface, wherein the protruding micro-structures and the first light guide micro-structures are distributed alternatively. The light source is disposed beside the light entering surface. The reflective sheet is disposed at a side of the light reflecting surface and the reflective sheet is in contact with the protruding micro-structures.

The invention is also directed to an LCD including the above-mentioned backlight module and a liquid crystal panel. The liquid crystal panel is opposite to the backlight module and the liquid crystal panel is located at a side of the light exiting surface of the light guide panel.

According to an embodiment of the invention, the first light guide micro-structures are embedded in the light guide panel.

According to an embodiment of the invention, cross-sections of the first light guide micro-structures are selected from squares, rectangles, rhombuses, circles, ellipses, triangles, wavy shapes, and a combination thereof

According to an embodiment of the invention, a distribution density of the first light guide micro-structures is gradually increased with an increase of a distance away from the light source.

According to an embodiment of the invention, the above-mentioned backlight module further includes a plurality of second light guide micro-structures disposed on the light guide panel and distributed at the light exiting surface.

According to an embodiment of the invention, the protruding micro-structures are electrostatic discharging (ESD) protecting micro-structures.

In view of the above, the light guide panel in the backlight module according to the invention has the first light guide micro-structures and the protruding micro-structures. By the protruding micro-structures having the function of preventing from the accumulation of the static electricity, the reflective sheet is not attached to the light guide panel due to the attracting effect of the static electricity. Accordingly, the reflective sheet can provide uniform reflective effect and further facilitate the backlight module providing uniform planar light source. Furthermore, the protruding micro-structures also has the light transmission function. Owing that the first light guide micro-structures and the protruding micro-structures are distributed alternatively at the light reflecting surface of the light guide panel, the two can work in coordination with each other to enhance the transmission effect of the light.

In order to make the aforementioned and other features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic three-dimensional view of a backlight module according to an embodiment of the invention.

FIG. 2 is a schematic three-dimensional view of a light guide panel in the backlight module depicted in FIG. 1.

FIG. 3 is a schematic three-dimensional view of another backlight module according to an embodiment of the invention.

FIG. 4 is a schematic view of an apparatus for fabricating the light guide panel according to an embodiment of the invention.

FIG. 5 is a schematic view of an LCD according to an embodiment of the invention.

### DESCRIPTION OF EMBODIMENTS

### Backlight Module

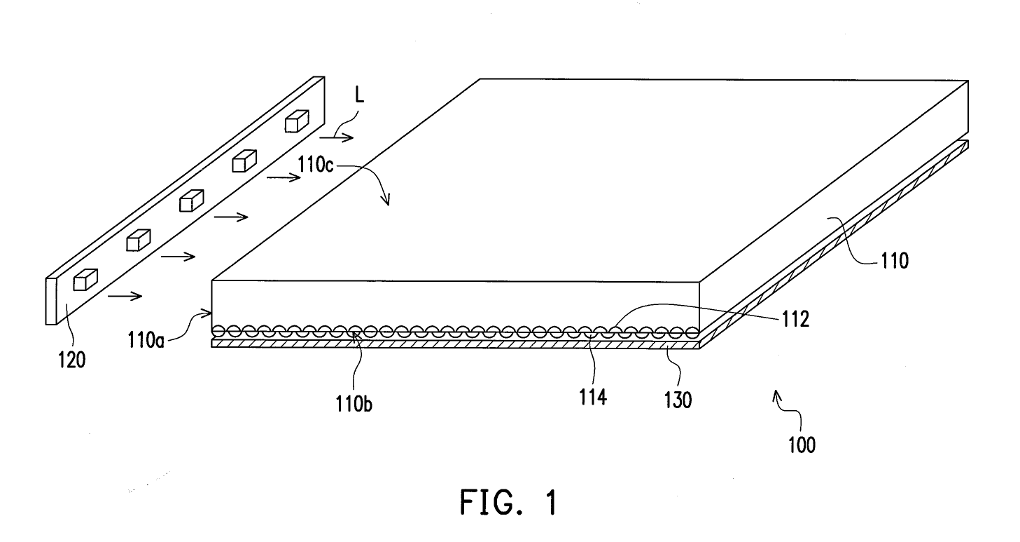

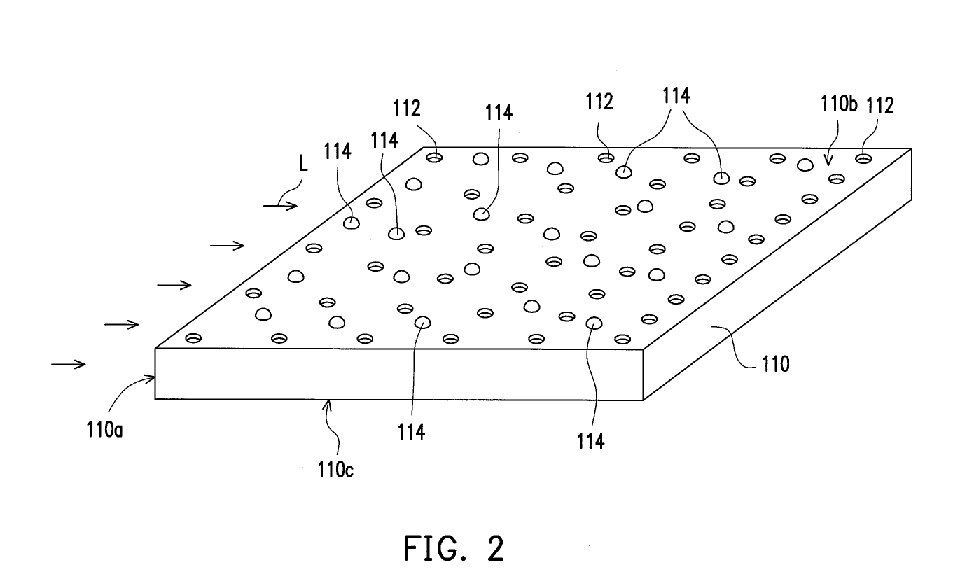

FIG. 1 is a schematic three-dimensional view of a backlight module according to an embodiment of the invention. FIG. 2 is a schematic three-dimensional view of a light guide panel in the backlight module depicted in FIG. 1. Referring to FIG. 1 and FIG. 2 simultaneously, a backlight module 100 includes a light guide panel 110, a light source 120, and a reflective sheet 130. The light guide panel 110 has a light entering surface 110a, a light reflecting surface 110b, and a light exiting surface 110c. The light guide panel 110 includes a plurality of first light guide micro-structures 112 and a plurality of protruding micro-structures 114. The first light guide micro-structures 112 are disposed on the light guide panel 110 and distributed at the light reflecting surface 110b. The protruding micro-structures 114 are disposed on the light guide panel 110 and distributed at the light reflecting surface 110b, wherein the protruding micro-structures 114 and the first light guide micro-structures 112 are distributed alternatively. The light source 120 is disposed beside the light entering surface 110a and the light source 120 can emit a light L. The reflective sheet 130 is disposed at a side of the light reflecting surface 110b and the reflective sheet 130 is in contact with the protruding micro-structures 114.

The light guide panel 110 shown in FIG. 2 is the view of that depicted in FIG. 1 turned 180 degrees, i.e. turned upside down, such that the light reflecting surface 110b is clearly shown in FIG. 2, which is conducive to presenting the dispositions of the first light guide micro-structures 112. FIG. 2 shows the dispositions and the distributions of the plurality of first light guide micro-structures 112 and the plurality of protruding micro-structures 114. The first light guide micro-structures 112 can be embedded in the light guide panel 110 such that the first light guide micro-structures 112 are avoided from rubbing with the external film sheet, such as the reflective sheet 130, which prevents the light guide effect of the first light guide micro-structures 112 from being negatively influenced. Alternately, the first light guide micro-structures 112 can be protruded from the surface of the light guide panel 110 (not shown), which is determined according to the design thereof. The first light guide micro-structures 112 are not limited to be embedded in the light guide panel 110 or protruded from the light guide panel 110 herein.

The cross-sections of the first light guide micro-structures 112 shown in FIG. 2 can be circles. Nevertheless, the cross-section of the first light guide micro-structures 112 can be other shapes, e.g. the shapes selected from squares, rectangles, rhombuses, ellipses, triangles, wavy shapes, and a combination thereof (not shown). Furthermore, the first light guide micro-structures 112 configured on the reflecting surface 110b of the light guide panel 110 can have a variety of cross-sections (such as a rectangle, a rhombus, a circle, an ellipse, a triangle, a wavy shape, and a combination thereof) and are arbitrarily combined with one another.

As shown in FIG. 2, the distribution density of the first light guide micro-structures 112 can be gradually increased with the increase of the distance away from the light source 120, i.e. gradually increased along with the direction of the light transmission of the light L. Owing that the intensity of the light L is gradually reduced with the increase of the distance away from the light source 120, the amount of the first light guide micro-structures 112 disposed at the position farther from the light source 120 is increased, i.e. the distribution density of the first light guide micro-structures 112 disposed at the position farther from the light source 120 is high, which effectively enhances the reflectivity of the light L at the position farther from the light source 120. As such, the light guide panel 110 can provide even more uniform planar light source. However, the distribution density and the distribution method of the first light guide micro-structures 112 can be determined according to the design requirement, wherein the first light guide micro-structures 112 can be regularly distributed or irregularly distributed, which is not limited herein.

It is noted that the protruding micro-structures 114 and the first light guide micro-structures 112 on the light guide panel 110 are distributed alternatively, i.e. the protruding micro-structures 114 are evenly distributed among the plurality of the first light guide micro-structures 112. The protruding micro-structures 114 can be the ESD protecting micro-structures. For example, the protruding micro-structures 114 can be processed by an ESD protecting treatment, such that the protruding micro-structures 114 can have the ESD protecting function. Accordingly, every region of the light guide panel 110 can be avoided from the accumulation of the static electricity, which prevents the reflective sheet 114 from being attached to particular region of the light guide panel 110. Therefore, uniform planar light source can be provided.

Furthermore, the protruding micro-structures 114 can also have the light transmission effect. When the first light guide micro-structures 112 and the protruding micro-structures 114 are distributed alternatively, the first light guide micro-structures 112 and the protruding micro-structures 114 can work in coordination with each other to enhance the transmission effect and the utility of light L. As a result, the optical effect of the light guided panel 110 can be enhanced.

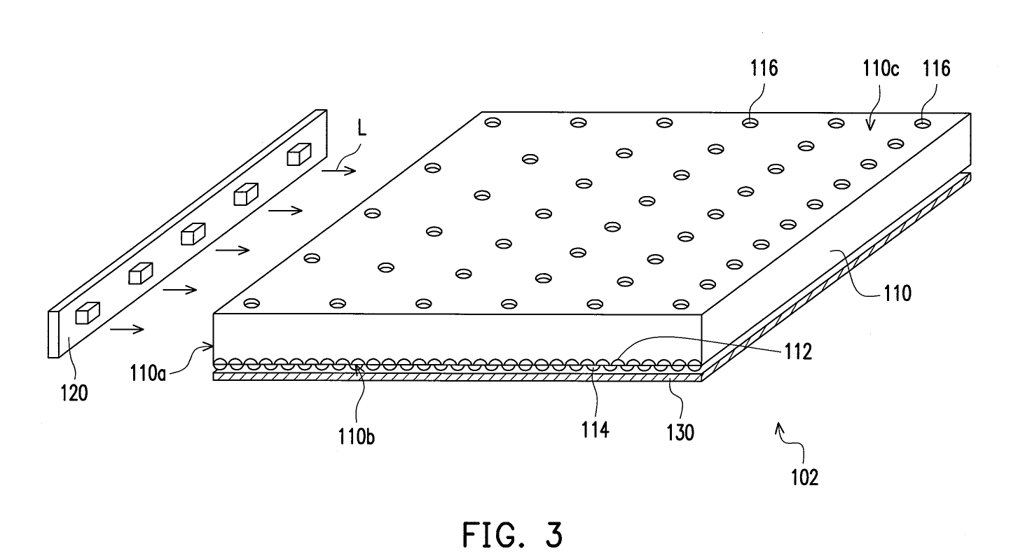

FIG. 3 is a schematic three-dimensional view of another backlight module according to an embodiment of the invention. Referring to FIG. 3, the backlight module 102 is similar to the backlight module 100 and the same components therein are marked by the same reference numbers. The backlight module 102 as shown in FIG. 3 can further include a plurality of second light guide micro-structures 116 disposed on the light guide panel 110 and distributed at the light exiting surface 110c.

By the additional disposition of the second light guide micro-structures 116, the optical effect of the light guide panel 100 can be further enhanced to provide the planar light source having better uniformity. Similarly, the second light guide micro-structures 116 can be embedded in the light guide panel 110 or protruded from the light guide panel 110. The distribution method and the distribution density of the second light guide micro-structures 116 can be similar to those of the first light guide micro-structures 112 or be arranged according to other proper design, which is determined based on the design requirement.

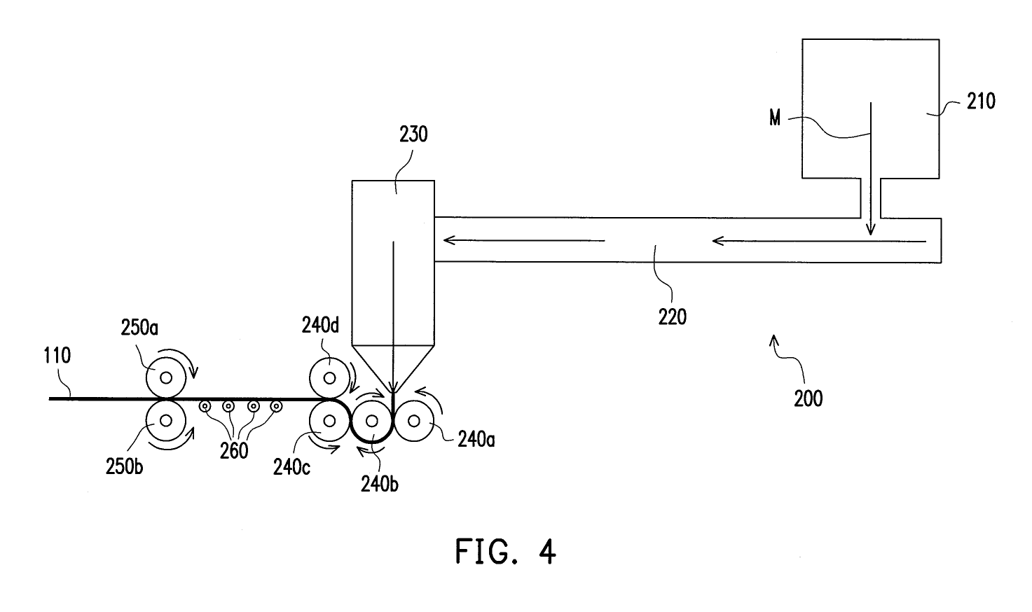

FIG. 4 is a schematic view of an apparatus for fabricating the light guide panel according to an embodiment of the invention. Referring to FIG. 1, FIG. 2, and FIG. 4 together, the apparatus 200 for fabricating the light guide panel includes the raw material tank 210, the heating screw 220, a pressing die 230, forming rollers 240a˜240d, drawing rollers 250a˜250b, and transporting rollers 260. In the following, the fabrication process of the light guide panel 110 is introduced.

First, the raw material particles M of the light guide panel 110 (for example, the particles of transparent material such as PMMA) are placed in the raw material tank 210. Next, the raw material particles M are transported to the heating screw 220 for being heated and melted. Subsequently, the melted transparent gel of the raw material particles M is transported to the external environment through the pressing die 230 and then a forming process for forming the light guide panel 110 is performed by using the forming rollers 240a˜240d. The forming rollers 240a˜240d can control the thickness of the light guide panel 110 and fabricate the first light guide micro-structures 112 and the protruding micro-structures 114 on the surface of the light guide panel 110.

Specifically, the thickness of the pressed-forming light guide panel 110 can be controlled by moving the forming roller 240a left and right (i.e. the left and right directions in FIG. 4).

Furthermore, the surface of the forming roller 240b can be formed with concave structures, wherein the cross-sections of the concave structures can be any shape such as a square, a rectangle, a rhombus, an ellipse, a triangle, a circle, a wavy shape, and the like. The surface (the light reflecting surface 110b) of the light guide panel 110 can be thus formed with the protruding structures (corresponding to the concave structures of the forming roller 240b) when the light guide panel 110 is pressed by the forming roller 240b, i.e. the above-mentioned protruding micro-structures 114 protruded from the light guide panel 110 are formed. Furthermore, the ESD protecting treatment can be processed directly on the formed protruding micro-structures 114 by using the forming roller 240b, which renders the protruding micro-structures 114 has the function of avoiding the accumulation of the static electricity.

The surface of the forming roller 240d can be formed with convex structures, wherein the cross-sections of the convex structures can be any shape such as a square, a rectangle, a rhombus, an ellipse, a triangle, a circle, a wavy shape, and the like. The surface (the light reflecting surface 110b) of the light guide panel 110 can be thus formed with the concave structures (corresponding to the convex structures of the forming roller 240d) when the light guide panel 110 is pressed by the forming roller 240d, i.e. the above-mentioned first light guide micro-structures 112 embedded in the light guide panel 110 are formed.

It is to say that the forming roller 240b and the forming roller 240d have the surface micro-structures with the curvature directions opposite to each other and the forming roller 240b and the forming roller 240d can alternatively press on the light reflecting surface 110b of the light guide panel 110, such that the protruding micro-structures 114 protruding from the light guide panel 110 and the first light guide micro-structures 112 embedded in the light guide panel 110 are obtained.

In addition, the surface of the forming roller 240c can be formed with convex structures, wherein the cross-sections of the convex structures can be any shape such as a square, a rectangle, a rhombus, an ellipse, a triangle, a circle, a wavy shape, and the like. The surface (the light exiting surface 110c) of the light guide panel 110 can be thus formed with the concave structures (corresponding to the convex structures of the forming roller 240c) when the light guide panel 110 is pressed by the forming roller 240c, i.e. the above-mentioned second light guide micro-structures 116 embedded in the light guide panel 110 are formed.

In addition, the surface structure configured on the forming rollers 240b˜240d can be concave structures or convex structures, which is determined according to the design requirement and can be properly combined with one another. The above-mentioned configuration is not intent to limit the scope of the invention.

The drawing rollers 250a˜250b are used for providing the drawing force to drag the light guide panel 110 and the light guide panel 110 can be transported on the transporting roller 260. The first light guide micro-structures 112, the protruding micro-structures 114, and the second light guide micro structures 116 of the light guide panel 110 can be fabricated in the same process according to the foregoing fabrication of the light guide panel 110, and thus the competitive advantage of saving the fabricating process is achieved.

Certainly, the light guide panel 110 can be fabricated by a method including two fabricating processes. That is to say, the first light guide micro-structures 112 embedded in the light guide panel 110 can be formed in the first fabricating process by using the forming roller 240d. Subsequently, in the second fabricating process, the ESD protecting particles can be sprayed on the light reflecting surface 110b of the light guide panel 110 and a baking process is performed to form the aforesaid protruding micro-structures 114.

In light of the foregoing, the light guide panel 110 has the first light guide micro-structures 112 and the protruding micro-structures 114 alternatively distributed. The reflective sheet 116 is not attached to the light guide panel 110 through the configuration of the protruding micro-structures 114 and the light transmission effect can be further enhanced by the coordination of the first light guide micro-structures 112 and the protruding micro-structures 114.

### Liquid Crystal Display

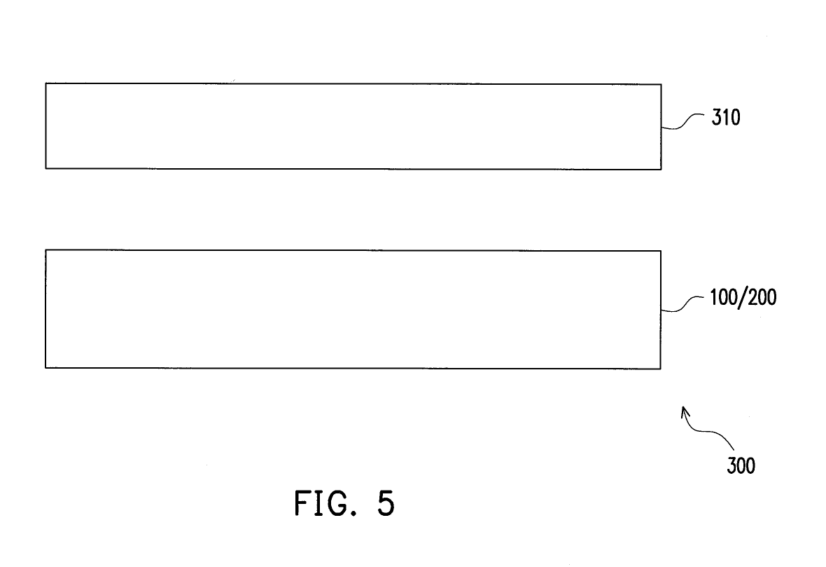

FIG. 5 is a schematic view of an LCD according to an embodiment of the invention. Referring to FIG. 1 and FIG. 5 together, the LCD 300 can include the aforesaid backlight module 100/102 and the liquid crystal panel 310. The liquid crystal panel 310 is opposite to the backlight module 100/102 and the liquid crystal panel 310 is located at a side of the light exiting surface 110c of the light guide panel 110. The LCD 300 adopting the above-mentioned backlight module 100/102 capable of providing uniform planar light source can display images with desirable quality.

In summary, the backlight module and the LCD according to the invention at least have the following advantages:

The light guide panel has the first light guide micro-structures and the protruding micro-structures alternatively distributed. By the protruding micro-structures having the function of preventing from the accumulation of the static electricity, the reflective sheet is not attached to the light guide panel due to the attracting effect of the static electricity. Accordingly, the light guide panel can provide uniform light reflective effect and further facilitates the backlight module providing uniform planar light source. Furthermore, the protruding micro-structures also has the light transmission function. Owing that the first light guide micro-structures and the protruding micro-structures are distributed alternatively at the light reflecting surface of the light guide panel, the two can work in coordination with each other to enhance the transmission effect of the light.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A backlight module comprising:
a light guide panel having a light entering surface, a light reflecting surface, and a light exiting surface, the light guide panel comprising:
a plurality of first light guide micro-structures disposed on the light guide panel and distributed at the light reflecting surface;
a plurality of protruding micro-structures disposed on the light guide panel and distributed at the light reflecting surface, wherein the protruding micro-structures and the first light guide micro-structures are distributed alternatively;
a light source disposed beside the light entering surface; and
a reflective sheet disposed at a side of the light reflecting surface and the reflective sheet being in contact with the protruding micro-structures.

2. The backlight module according to claim 1, wherein the first light guide micro-structures are embedded in the light guide panel.

3. The backlight module according to claim 1, wherein cross-sections of the first light guide micro-structures are selected from squares, rectangles, rhombuses, circles, ellipses, triangles, wavy shapes, and a combination thereof.

4. The backlight module according to claim 1, wherein a distribution density of the first light guide micro-structures is gradually increased with an increase of a distance away from the light source.

5. The backlight module according to claim 1, further comprising:
a plurality of second light guide micro-structures disposed on the light guide panel and distributed at the light exiting surface.

6. The backlight module according to claim 1, wherein the protruding micro-structures are electrostatic discharging (ESD) protecting micro-structures.

7. A liquid crystal display (LCD), comprising:
a backlight module comprising:
a light guide panel having a light entering surface, a light reflecting surface, and a light exiting surface, the light guide panel comprising:
a plurality of first light guide micro-structures disposed on the light guide panel and distributed at the light reflecting surface;
a plurality of protruding micro-structures disposed on the light guide panel and distributed at the light reflecting surface, wherein the protruding micro-structures and the first light guide micro-structures are distributed alternatively;
a light source disposed beside the light entering surface;
a reflective sheet disposed at a side of the light reflecting surface and the reflective sheet being in contact with the protruding micro-structures; and
a liquid crystal panel opposite to the backlight module and the liquid crystal panel being located at a side of the light exiting surface of the light guide panel.

8. The liquid crystal display according to claim 7, wherein the first light guide micro-structures are embedded in the light guide panel.

9. The liquid crystal display according to claim 7, further comprising:
a plurality of second light guide micro-structures disposed on the light guide panel and distributed at the light exiting surface.

10. The liquid crystal display according to claim 7, wherein the protruding micro-structures are ESD protecting micro-structures.
